(19) United States
(12) Patent Application Publication
(10) Pub. No.: US 2006/0103857 A1
(43) Pub. Date: May 18, 2006

(54) Method of reducing a consumption of imaging substance when forming an image

(75) Inventor: Daryl Edward Janisch, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 10/991,650

(22) Filed: Nov. 17, 2004

(51) Int. Cl. G06F 3/12; G06F 15/00; G06K 1/00

(52) U.S. Cl. 358/1.1

(57) ABSTRACT

A method of reducing a consumption of imaging substance when forming an image includes placing an object in an electronic form on a grid, the grid having a plurality of grid units arranged in rows and columns, wherein each grid unit containing a portion of the object is represented by a first designation and each grid unit not containing a portion of the object is represented by a second designation; and determining from among the plurality of grid units each grid unit initially having the first designation at an interior portion of the object that will be converted to the second designation in a conversion process.

### BACKGROUND OF THE INVENTION

1. Field of the Invention

The present invention relates to an imaging apparatus, and, more particularly, to a method of reducing a consumption of imaging substance when forming an image.

2. Description of the Related Art

During a typical printing process, an image is formed on a substrate, such as a sheet of paper, by applying dots of imaging substance, such as ink or toner, to the substrate at predetermined locations. The higher the number of imaging substance dots used to form the image, the greater the consumption of the imaging substance from the imaging substance supply.

### SUMMARY OF THE INVENTION

The present invention provides a method of reducing a consumption of imaging substance when forming an image. The method includes placing an object in an electronic form on a grid, the grid having a plurality of grid units arranged in rows and columns, wherein each grid unit containing a portion of the object is represented by a first designation and each grid unit not containing a portion of the object is represented by a second designation; and determining from among the plurality of grid units each grid unit initially having the first designation at an interior portion of the object that will be converted to the second designation in a conversion process.

The invention, in another form thereof, is directed to a method of reducing a deformation of a substrate receiving ink by reducing an amount of ink used in forming an object on the substrate. The method includes placing the object in an electronic form on a grid, the grid having a plurality of grid units arranged in rows and columns, wherein each grid unit containing a portion of the object is represented by a first designation and each grid unit not containing the portion of the object is represented by a second designation; determining from among the plurality of grid units each grid unit initially having the first designation at an interior portion of the object that will be converted to the second designation in a conversion process; performing the conversion process; and forming an image of the object on a substrate based on the first designation and the second designation resulting from the conversion process.

An advantage of the present invention is that the consumption of an imaging substance, such as ink or toner, during the formation of an image on a substrate, such as a sheet of paper, is reduced.

Another advantage of the present invention is that the consumption of an imaging substance is reduced, while maintaining image sharpness by preserving image edges.

Another advantage of the present invention is that reducing the amount of ink used to form an image on a sheet of paper during printing results in less wetting of the sheet of paper, and accordingly, a deformation of the sheet of paper due to paper wetting by the ink is reduced.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an imaging system embodying the present invention.

FIG. 2 is a diagrammatic representation of an exemplary supply item configured as an ink jet printhead cartridge.

FIG. 3 is a flowchart of a method of reducing a consumption of imaging substance when forming an image, in accordance with an embodiment of the present invention.

FIG. 4 is a diagrammatic representation of a grid including a plurality of grid units and including an object placed on the grid.

FIG. 5 is an exemplary algorithm, which may be used in determining whether a particular grid unit may be changed from a first designation to a second designation.

FIG. 6 shows in a diagrammatic representation of the results of application of the algorithm of FIG. 5 to the object on the grid of FIG. 4.

FIG. 7 is diagrammatic representation of text characters after application of the method of the present invention, wherein reduction of ink usage of about 35% is achieved over the same text characters printed in the absence of the application of the method of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

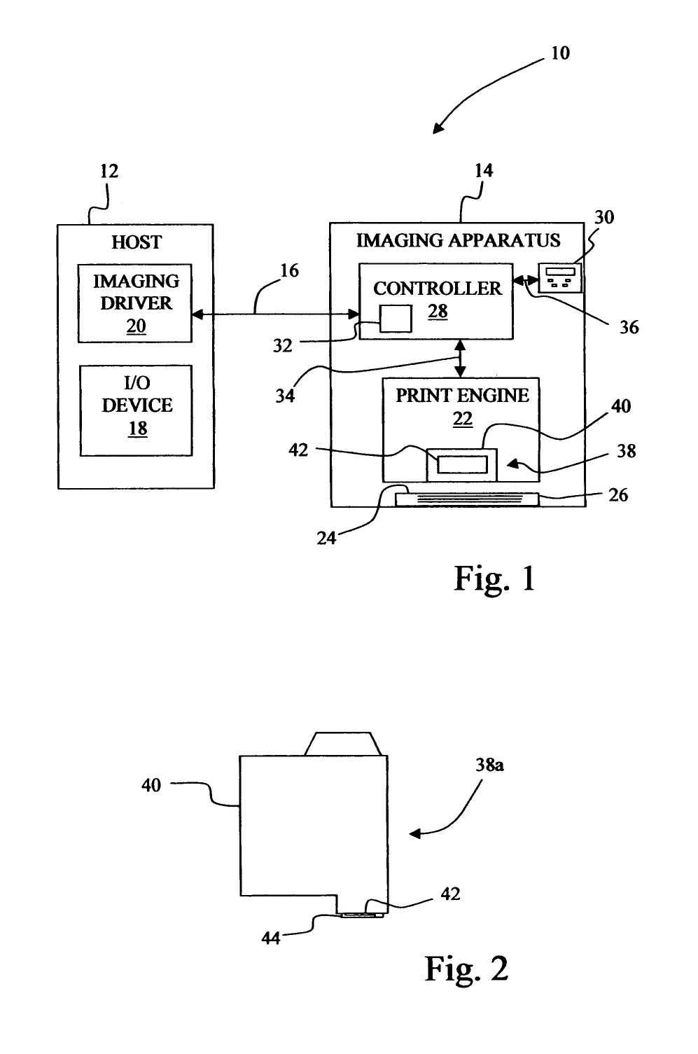

FIG. 1 is a diagrammatic depiction of a system 10 embodying the present invention. System 10 may include a host 12 and an imaging apparatus 14, with imaging apparatus 14 communicating with host 12 via a communications link 16. As used herein, the term “communications link” is used to generally refer to structure that facilitates electronic communication between two components, and may operate using wired or wireless technology. Communications link 16 may be established, for example, by a direct cable connection, wireless connection or by a network connection such as for example an Ethernet local area network (LAN).

In embodiments including host 12, host 12 may be, for example, a personal computer including an input/output (I/O) device 18, such as keyboard and display monitor. Host 12 further includes a processor, input/output (I/O) interfaces, memory, such as RAM, ROM, NVRAM, and may include a mass data storage device, such as a hard drive, CD-ROM and/or DVD units. During operation, host 12 includes in its memory a software program including program instructions that function as an imaging driver 20, e.g., printer driver software, for imaging apparatus 14. Imaging driver 20 facilitates communication between host 12 and imaging apparatus 14, and may provide formatted print data to imaging apparatus 14.

In a system that includes host 12 communicatively coupled to imaging apparatus 14, imaging apparatus 14 may be configured to operate as a printer, including a print engine 22. Print engine 22 may be, for example, in the form of an electrophotographic (e.g., laser) print engine, a thermal print engine or an ink jet print engine. Print engine 22 is configured for forming an image on a sheet of print media 24, such as for example, plain paper, coated paper, photo paper and transparency media, picked from a stack of print media 26.

Such a printer may be, for example, an ink jet printer having an ink jet print engine, an electrophotographic (e.g., laser) printer having an electrophotographic (EP) print engine, or a thermal printer having a thermal print engine. Of course, imaging apparatus 14 may be a multifunction machine that includes other functions, such as for example, copying or facsimile functions, in addition to printing.

Alternatively, imaging apparatus 14 may be a standalone unit that is not communicatively linked to a host, such as host 12. For example, imaging apparatus 14 may take the form of a multifunction machine that includes standalone copying and facsimile capabilities, in addition to optionally serving as a printer when attached to a host, such as host 12. Such a multifunction unit may include print engine 22, and is configured to perform standalone functions, such as copying or facsimile receipt and transmission.

Imaging apparatus 14 further includes a controller 28 and a user interface 30. Controller 28 includes a processor unit, a memory 32 and associated interface circuitry, and may be formed as an Application Specific Integrated Circuit (ASIC). Controller 28 communicates with print engine 22 via a communications link 34. Controller 28 communicates with user interface 30 via a communications link 36. Communications links 34 and 36 may be established, for example, by using standard electrical cabling or bus structures, or by wireless connection.

In embodiments including host 12, imaging driver 20 is in communication with controller 28 of imaging apparatus 14 via communications link 16, and may provide formatted print data to imaging apparatus 14, and more particularly, to print engine 22. Alternatively, however, all or a portion of imaging driver 20 may be incorporated into controller 28 of imaging apparatus 14. Likewise, all or a portion of controller 28 may be incorporated into host 12.

Associated with imaging apparatus 14 is at least one supply item 38, such as for example an ink jet printhead cartridge or an EP cartridge. Supply item 38 is received into print engine 22. Supply item 38 may include an imaging substance reservoir 40 for holding a supply of imaging substance, such as one or more colors of ink or toner, e.g., monochrome (black), cyan, magenta and/or yellow, and/or diluted forms thereof. For example, in embodiments where print engine 22 is an ink jet print engine, then the imaging substance is ink. In embodiments wherein print engine 22 is an EP print engine, then the imaging substance is toner, which may be in dry or liquid form. It is contemplated that imaging apparatus 14 may simultaneously accommodate multiple supply items 38.

Referring now to FIGS. 1 and 2, each supply item 38 may respectively include an electronic circuit 42, including a memory and interface circuitry, for facilitating communications with controller 28. FIG. 2 shows an exemplary embodiment of supply item 38 in the form of an ink jet printhead cartridge 38a. Ink jet printhead cartridge 38a includes at least one printhead 44, which includes a nozzle plate for ejecting ink droplets in forming an imaging on the sheet of print media 24. Electronic circuit 42 may be formed as a part of the silicon of printhead 44.

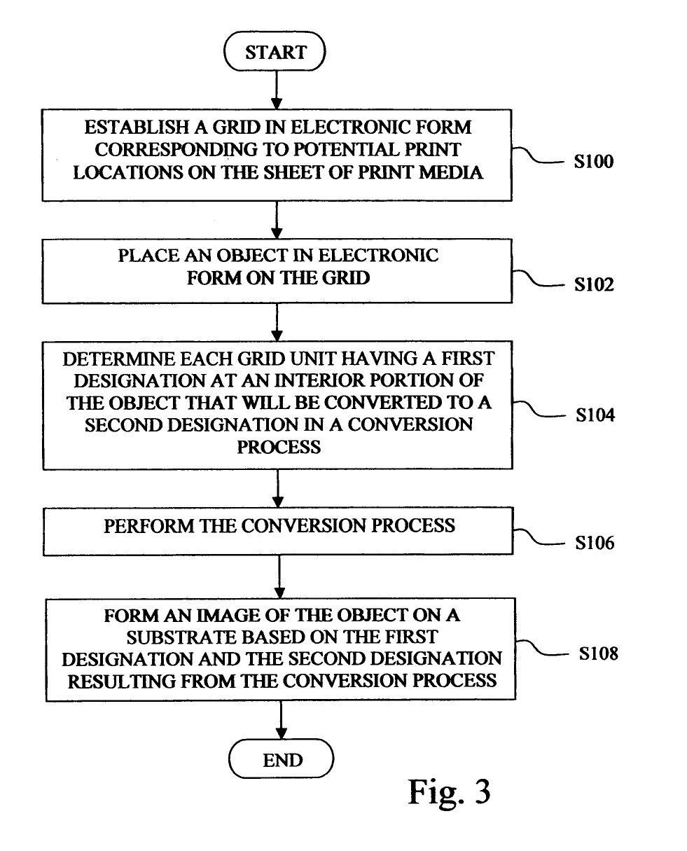

FIG. 3 is a flowchart of a method of reducing a consumption of imaging substance when forming an image, such as an image formed using imaging apparatus 14, in accordance with an embodiment of the present invention. The method may be performed by software present, for example, in imaging driver 20, which may be located in host 12 or imaging apparatus 14.

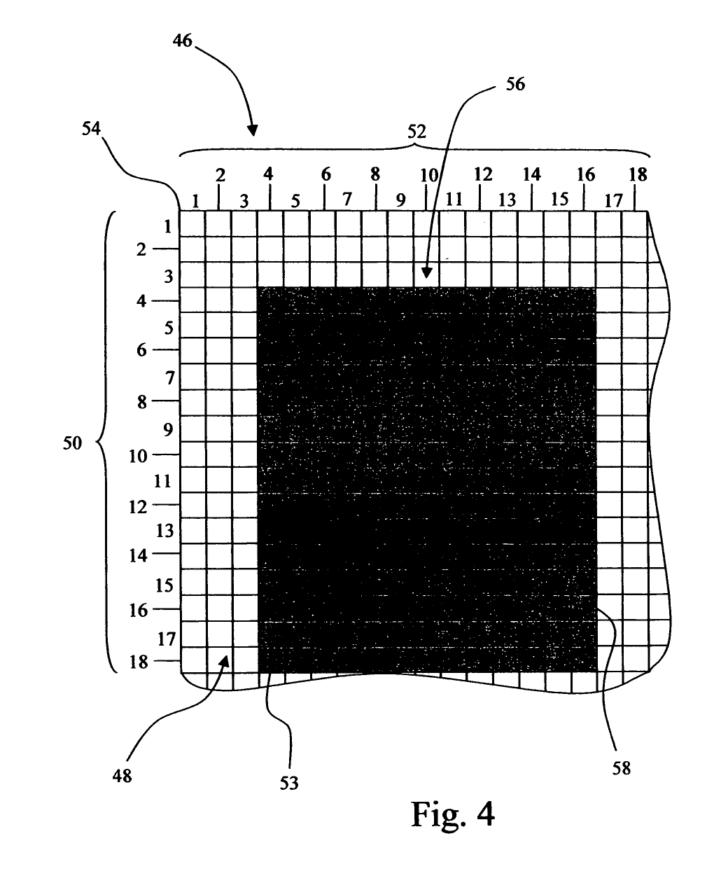

At step S100, a grid 46 is established in electronic form which corresponds to potential print locations on the sheet of print media 24. Referring to FIG. 4, grid 46 has a plurality of grid units 48, represented as squares in grid 46, arranged in rows 50 and columns 52. In this example, individual rows are referenced by coordinates 50-1 through 50-18, and individual columns are referenced as coordinates 52-1 through 52-18. Accordingly, a combination of (row, column) coordinates will correspond to a particular grid unit of the plurality of grid units 48. For example, exemplary grid unit 53 may be referenced by coordinates (50-18, 52-4). The orthogonal distance between the lines of grid 46 may be determined by the size of the object or objects to be placed on grid 46. Therefore, for example, the smaller the object, the smaller the grid it will be placed upon. In grid 46 shown in FIG. 4, the grid units 48 numerically increase along both axes from the origin point 54 in the upper left corner. The origin point, however, may be located at other positions as desired, such as for example, at the lower left corner.

At step S102, an object 56, such as punctuation point, e.g., a period as shown in this example, or text, is placed in an electronic form on grid 46. Initially, each grid unit containing a portion of object 56 is represented by a first designation and each grid unit not containing a portion of object 56 is represented by a second designation. Each grid unit represents a pixel of color information, wherein the first designation is a first pixel color, e.g., darkened (black), and the second designation is at least one different pixel color, e.g., lightened (white). Thus, for example, the first designation may correspond to a grid unit designated to receive imaging substance and the second designation may correspond to a grid unit designated to not receive the imaging substance.

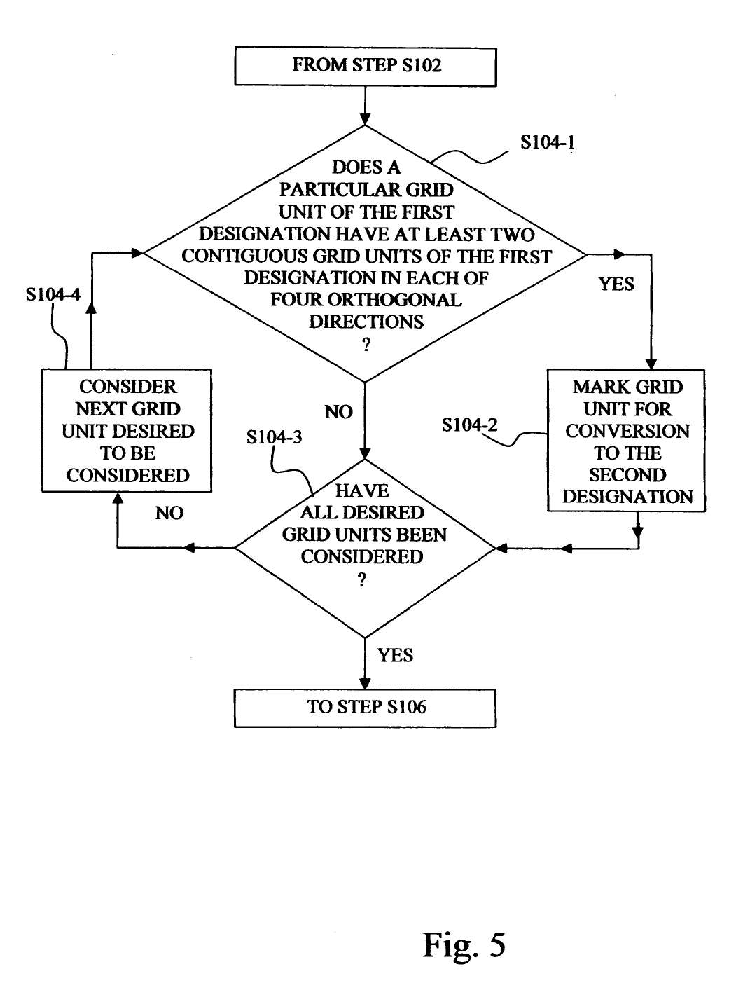

At step S104, it is determined from among the plurality of grid units 48 each grid unit initially having the first designation e.g., darkened (e.g., black), at an interior portion of object 56 that will be converted to the second designation, e.g., light (e.g., white) in a conversion process. This determination may be made by the application of an algorithm to at least some of the plurality of grid units 48. The grid units selected for conversion are changed from the first designation to the second designation, and will result in a reduction of the amount of imaging substance used to complete the imaging of object 56 on the sheet of print media 24. An exemplary algorithm for determining whether or not to convert a selected grid unit from the first designation to the second designation will be described in more detail below with respect to FIG. 5.

In an embodiment of the present invention, the act of determining of step S104 may be performed without determining a perimeter of object 56. Also, in an embodiment of the present invention, the act of step S104 may be performed while not changing the first designation of any of the plurality of grid units located on, or within a predetermined distance from, a perimeter 58 of object 56.

Further, in an embodiment of the present invention, the act of determining does not apply the algorithm to each grid unit of the plurality of grid units 48, but rather, applies the algorithm to a subset of the plurality of grid units 48.

The subset may include, for example, first-non-adjacent grid units in first non-adjacent rows and second non-adjacent grid units in second non-adjacent rows. The first non-adjacent rows may be, for example, one of odd rows (50-1, 50-3, 50-5, etc.) and even rows (50-2, 50-4, 50-6, etc.), and the second non-adjacent rows may be the other of the odd rows and even rows. The first-non-adjacent grid units may be, for example, one of odd grid units and even grid units in columns 52, and the second non-adjacent grid units may be the other of the odd grid units and the even grid units in columns 52. As a more specific example, the first-non-adjacent grid units (see columns 52-1, 52-3, 52-5, etc.) in the first non-adjacent rows (50-1, 50-3, 50-5, etc.), and the second non-adjacent grid units (see columns 52-2, 52-4, 52-6, etc.) in the second non-adjacent rows (50-2, 50-4, 50-6, etc.) may form a checkerboard pattern, to which the algorithm is applied.

Alternatively, the subset may include, for example, first-non-adjacent grid units in first non-adjacent columns and second non-adjacent grid units in second non-adjacent columns. The first non-adjacent columns may be, for example, one of odd columns (52-1, 52-3, 52-5, etc.) and even columns (52-2, 52-4, 52-6, etc.), and the second non-adjacent columns may be the other of the odd columns and even columns. The first-non-adjacent grid units may be, for example, one of odd grid units and even grid units in rows 50, and the second non-adjacent grid units may be the other of the odd grid units and the even grid units in rows 50.

At step S106, the conversion process is performed to convert the grid units determined in step S104 from the first designation to the second designation.

At step S108, an image of object 56 is formed on a substrate, e.g., the sheet of print media 24, based on the first designation and the second designation resulting from the conversion process.

FIG. 5 is an exemplary algorithm, which may be used in performing the act of determining each grid unit initially having the first designation at an interior portion of object 56 that will be converted to the second designation, as described above at step S104.

At step S104-1, the algorithm is applied to determine whether a particular grid unit of the plurality of grid units 48 of the first designation, e.g., dark, has at least two contiguous grid units of the first designation in each of four orthogonal directions with respect to that particular grid unit.

If, at step S104-1, the determination is YES, then at step S104-2 that particular grid unit is marked for conversion to the second designation, e.g., white, and the process proceeds to step S104-3.

If, at step S104-1, the determination is NO, then that particular grid unit is not converted to the second designation, and the process proceeds to step S104-3.

At step S104-3, it is determined whether all the desired grid units of the plurality of grid units have been considered. As set forth above, in one embodiment, the algorithm is applied only to a subset of the plurality of grid units 48. Those grid units of the plurality of grid units 48 desired to be considered for application of the algorithm may be individually considered by electronically scanning grid 46 horizontally along rows 50, or by scanning grid 46 vertically along columns 52.

If, at step S104-3, the determination is NO, then at step S104-4 the next grid unit is considered, and the process returns to step S104-1.

If, at step S104-3, the determination is YES, then the process returns to step S106 of FIG. 3.

Thus, the algorithm may be repeated for each grid unit of a designated subset of the plurality of grid units 48 until all grid units in the subset have been considered.

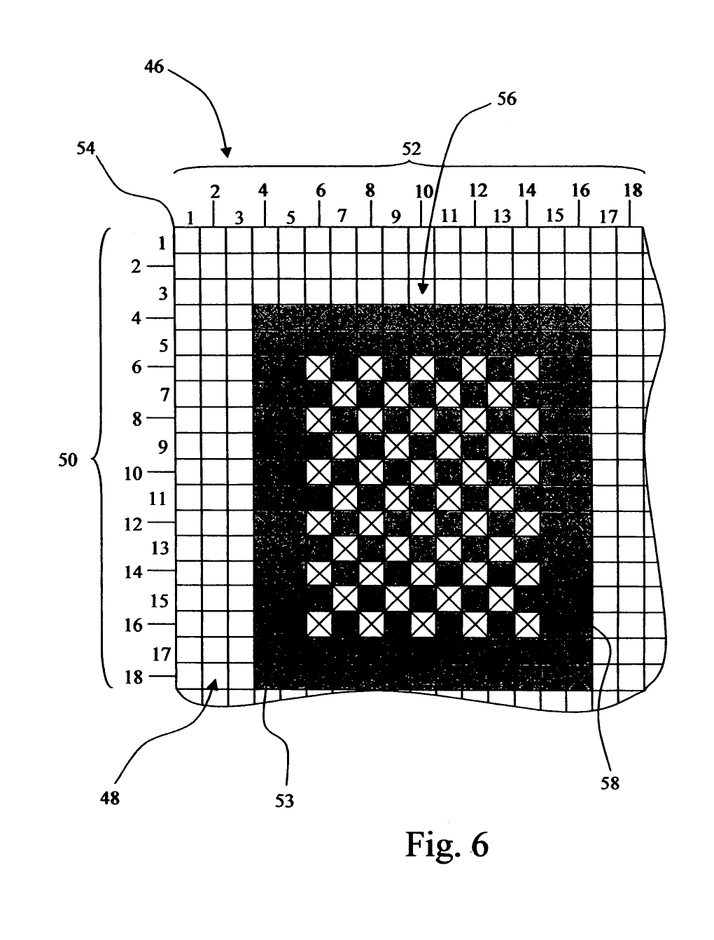

FIG. 6 shows the results of application of the algorithm of FIG. 5 to a subset of the plurality of grid units 48, wherein the subset is defined as the non-adjacent grid units (see columns 52-1, 52-3, 52-5, etc.) in the non-adjacent rows (50-1, 50-3, 50-5, etc.), and the non-adjacent grid units (see columns 52-2, 52-4, 52-6, etc.) in the non-adjacent rows (50-2, 50-4, 50-6, etc.). Stated in another way, in this example, the algorithm is applied to the grid units in object 56 designated by an X, which corresponds to (odd rows, odd columns) coordinates of grid units and (even rows, even columns) coordinates of grid units.

As set forth at step S104-1 of FIG. 5, the algorithm is applied to determine whether a particular grid unit of the plurality of grid units 48 of the first designation, e.g., dark, has at least two contiguous grid units of the first designation in each of four orthogonal directions with respect to that particular grid unit. If the determination is YES, then at step S104-2 that particular grid unit is marked to be changed to the second designation, e.g., white. In this particular example, as shown in FIG. 6, the coverage area on the substrate, e.g., the sheet of print media 24, is reduced by about 26 percent, which in turn corresponds to a reduction in the amount of imaging substance that will be used in forming object 56 on the sheet of print media 24. A greater percentage may be observed by decreasing the orthogonal distance between the grid lines of grid 46.

In an ink jet printing environment, for example, the method described above results in converting a black object, such as text, to a gray object by eliminating some of the interior pixels of the object. As a result, there is a reduced expenditure of ink on the interior of the object, while the external edge of the object remains unmodified. He reduction of expenditure of ink also results in less wetting of the sheet of print media 24, such as paper, thereby resulting in less distortion of the sheet of print media 24.

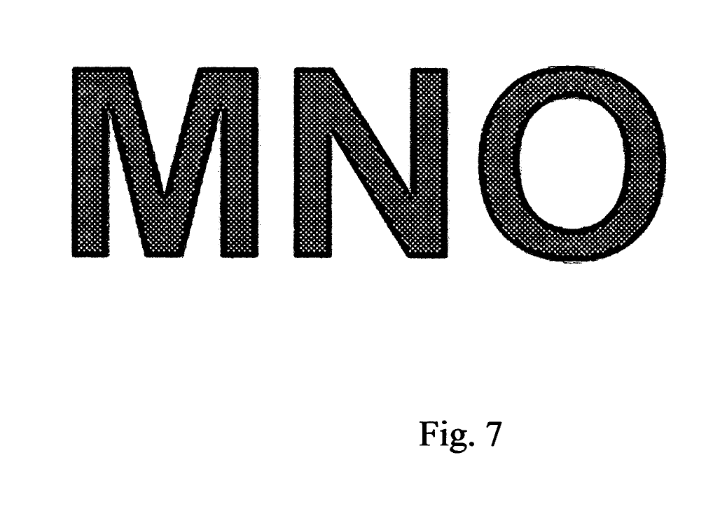

FIG. 7, shows the results of applying the method of the present invention to normally black text. As shown, the result is quality legible text while consuming only about 65% of the black ink that would be used to print the same text in solid black. As can be observed from FIG. 7, a reduction of the consumption of the imaging substance is achieved without adversely affecting the image sharpness of the text, since the perimeter of the text remains unchanged. This reduction in ink usage can be achieved without a change in printing speed, and this process can be used in all printing modes, e.g., draft, normal, best, etc.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of reducing a consumption of imaging substance when forming an image, comprising:
placing an object in an electronic form on a grid, said grid having a plurality of grid units arranged in rows and columns, wherein each grid unit containing a portion of said object is represented by a first designation and each grid unit not containing a portion of said object is represented by a second designation; and
determining from among said plurality of grid units each grid unit initially having said first designation at an interior portion of said object that will be converted to said second designation in a conversion process.

2. The method of claim 1, wherein said first designation corresponds to a grid unit designated to receive said imaging substance and said second designation corresponds to a grid unit designated to not receive said imaging substance, said method further comprising:
performing said conversion process; and
forming an image of said object on a substrate based on said first designation and said second designation resulting from said conversion process.

3. The method of claim 1, wherein each grid unit represents a pixel of color information, and wherein said first designation is a first pixel color and said second designation is at least one different pixel color.

4. The method of claim 3, wherein said first pixel color is dark and wherein said at least one different pixel color is light.

5. The method of claim 3, wherein said first pixel color is black and wherein said at least one different pixel color is white.

6. The method of claim 1, wherein the act of determining is performed without determining a perimeter of said object.

7. The method claim 1, wherein the act of determining is performed while not changing said first designation of any of said plurality of grid units located on a perimeter of said object.

8. The method of claim 1, wherein the act of determining comprises applying an algorithm to a subset of said plurality of grid units.

9. The method of claim 8, said subset including first-non-adjacent grid units in first non-adjacent rows and second non-adjacent grid units in second non-adjacent rows.

10. The method of claim 9, wherein said first-non-adjacent grid units is one of odd grid units and even grid units, and said second non-adjacent grid units is the other of said odd grid units and said even grid units.

11. The method of claim 10, wherein said first non-adjacent rows is one of odd rows and even rows, and said second non-adjacent rows is the other of said odd rows and said even rows.

12. The method of claim 9, said first-non-adjacent grid units in said first non-adjacent rows and said second non-adjacent grid units in said second non-adjacent rows form a checkerboard pattern.

13. The method of claim 8, wherein said subset of said plurality of grid units comprises first-non-adjacent grid units in first non-adjacent columns and second non-adjacent grid units in second non-adjacent columns.

14. The method of claim 13, wherein said first-non-adjacent grid units is one of odd grid units and even grid units, and said second non-adjacent grid units is the other of said odd grid units and said even grid units.

15. The method of claim 14, wherein said first non-adjacent columns is one of odd columns and even columns, and said second non-adjacent columns is the other of said odd columns and said even columns.

16. The method of claim 1, wherein the act of determining comprises applying an algorithm to determine whether a particular grid unit of said first designation has at least two contiguous grid units of said first designation in each of four orthogonal directions with respect to said particular grid unit, and if YES, then marking said particular grid unit to be changed to said second designation.

17. The method of claim 16, wherein the act of determining whether said particular grid unit of said first designation has at least two contiguous grid units of said first designation in each of four orthogonal directions with respect to said particular grid unit is repeated for each grid unit of a designated subset of said plurality of grid units.

18. The method of claim 1, wherein said imaging substance is ink.

19. The method of claim 18, wherein a deformation of a substrate receiving said object is reduced by reducing an amount of said ink used in forming said object on said substrate.

20. The method of claim 1, wherein an orthogonal distance between adjacent grid lines of said grid is determined by a size of said object.

21. A method of reducing a deformation of a substrate receiving ink by reducing an amount of ink used in forming an object on said substrate, comprising:
placing said object in an electronic form on a grid, said grid having a plurality of grid units arranged in rows and columns, wherein each grid unit containing a portion of said object is represented by a first designation and each grid unit not containing a portion of said object is represented by a second designation;
determining from among said plurality of grid units each grid unit initially having said first designation at an interior portion of said object that will be converted to said second designation in a conversion process;
performing said conversion process; and
forming an image of said object on a substrate based on said first designation and said second designation resulting from said conversion process.

22. The method of claim 21, wherein said first designation corresponds to a grid unit designated to receive ink and said second designation corresponds to a grid unit designated to not receive said ink.

23. The method of claim 21, wherein an orthogonal distance between adjacent grid lines of said grid is determined by a size of said object.
